(19) United States
(12) Patent Application Publication
(10) Pub. No.: US 2008/0264056 A1
(43) Pub. Date: Oct. 30, 2008

(54) Hydraulic buoyancey kinetic energy apparatus

(76) Inventor: Jui-Chi Tung, Taichung (TW)

Correspondence Address: PHILLIP LIU, 6980, WHITEOAK DR., RICHMOND, BC, V7EAZ9, CA

(21) Appl. No.: 11/790,498

(22) Filed: Apr. 26, 2007

(51) Int. Cl. F03B 17/02

(52) U.S. Cl. 60/496

(57) ABSTRACT

A hydraulic buoyancy kinetic energy apparatus includes a water tank filled with water and an air storage hood is merged in the water. Two buoys are movably connected to the two slippery pillars and a chain is connected with the two buoys via two chain wheels, two belt pulley sets and two engaged gears. One of the two gears drives a third chain wheel to drive an output shaft of an electric generating set. An air storage cylinder is connected with the water tank and air in the air storage cylinder can be pushed into the water tank to alternatively empty the two buoys which are alternatively moves up and down to drive the chain between the buoys and to activate the electric generating set.

### FIELD OF THE INVENTION

The present invention relates an electric power generating device which is driven by a force generated by alternatively moving buoys in a water tank and a chain and a pulley set are connected between the two buoys.

### BACKGROUND OF THE INVENTION

A conventional air buoyancy electric generator is disclosed in FIGS. 14 and 15 and generally employs an air compressor 01 to generate compressed air which is stored in a steel cylinder 03 through a duct 02 connected to between the compressor 01 and the steel cylinder 03. A valve 122 is connected to the duct 02 so as to control the compressed air into the steel cylinder 03. A water tank 04 filled with water and the compressed air in the steel cylinder 03 is discharged through a duct 05 to the water tank 04 from an air outlet 06 at the bottom of the water tank 04. A valve 222 is connected to the duct 05 so as to control the compressed air into the water tank 04. The discharged air is injected into an air chamber 08 disposed on the surface of the caterpillar band 07. In the meantime, a buoyancy rotates the caterpillar band 07 installed between an upper transmission shaft 091 and a lower transmission shaft 092, so that the upper transmission shaft 091 drives an electric generator 093 to rotate and produce electric power.

The prior art injects compressed air into the air chambers 08 in sequence to produce buoyancy, and uses the buoyancy to provide kinetic energy to drive the electric generator. Before this prior art generates electric power, it is necessary to consume power to run the air compressor to produce compressed air. In other words, the electric generator is useless without a power source. After the electric power is generated, it is necessary to consume part of the power to drive the air compressor, and thus decreasing the quantity of the generated electric power. The kinetic energy or power cannot be stored completely.

The present invention intends to provide a hydraulic buoyancy kinetic energy apparatus and the generator is activated by alternatively operation of two chambers in water. Compressed air is alternatively sent into the two chambers to change their positions in the water so as to rotate a shaft of the generator which is then activated to generate electric power.

### SUMMARY OF THE INVENTION

The present invention relates to a hydraulic buoyancy kinetic energy apparatus which comprises a water tank filled with water and an air storage hood is merged in the water. Two buoys are movably connected to two slippery pillars in the water tank and a chain is connected with the two buoys via two chain wheels. Two respective axes of the two chain wheels are connected to each other by two belt pulley sets and two engaged gears are mounted to the two belt pulley sets. One of the two gears has an output shaft and a third chain wheel is connected to the output shaft. The third chain wheel is connected to a electric generating set.

An air storage cylinder is connected with the water tank and air in the air storage cylinder pushed out from the air storage cylinder by introducing the water from the water tank. Two respective one-way valves are connected on two respective tops of the two buoys and located corresponding two trigger pipes on the air storage hood. An air duct is connected between the air storage hood and the air storage cylinder. A one-way valve is connected to the air duct. A pipe is connected between a lower portion of the water tank and the air storage cylinder. A three-way valve is connected to the pipe and has a handle which has one end thereof connected to a resilient member and the other end of the handle connected to a rope which is connected to a link rod on each of the one-way valves via a pulley set. The rope is pulled by either one of the two buoys so as to activate the three-way valve.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 discloses the hydraulic buoyancy kinetic energy apparatus of the present invention;

FIG. 2 shows the two buoys are alternatively moved up and down;

FIG. 3 shows is a front view of the hydraulic buoyancy kinetic energy apparatus of the present invention;

FIG. 4 shows is a side view of the hydraulic buoyancy kinetic energy apparatus of the present invention;

FIG. 5 shows a top view of the hydraulic buoyancy kinetic energy apparatus of the present invention;

FIG. 6 shows the two buoys changes their positions in the water tank;

FIG. 7 shows the rope connected between the two buoys;

FIG. 8 shows the rope is pushes by the buoy;

FIG. 9 shows the other embodiment of the hydraulic buoyancy kinetic energy apparatus of the present invention;

FIG. 10 shows the air storage cylinder is located in the water tank in the embodiment of FIG. 9;

FIG. 11 shows the air in the air storage cylinder is released to outside of the water tank in the embodiment of FIG. 9;

FIG. 12 shows the air in the air storage cylinder is released into the water in the water tank in the embodiment of FIG. 9, and

FIG. 13 shows that air is introduced into the air storage cylinder and the water in the air storage cylinder flows out from the air storage cylinder.

### DETAILED DESCRIPTION OF THE PREFERRED EMBODIMENT

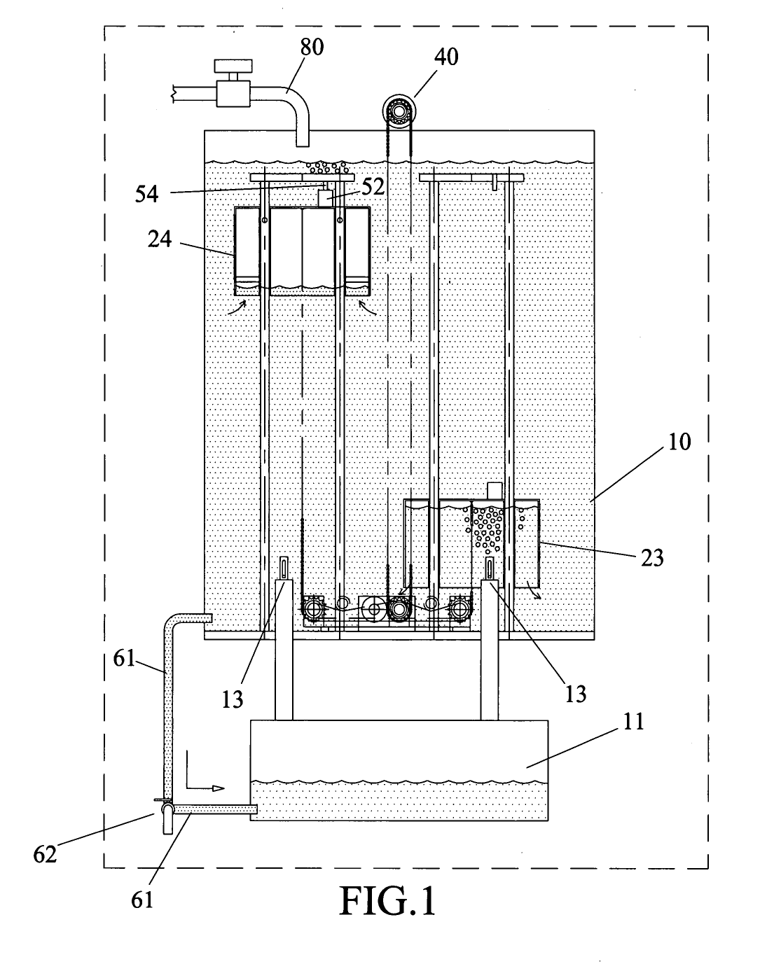

Referring to FIG. 1, the hydraulic buoyancy kinetic energy apparatus of the invention comprises a water tank 10, an air storage cylinder 11 located under the bottom of the water tank 10. A water supply source 80 provides water into the water tank 10 to keep the level of the water in the water tank 10 at high position. An upper level detector 101 and a low level detector 102 are connected to the water tank 10 so as to control the water supply source 80 to keep the water level at the high or full level. The water tank 10 includes an open top communicating with outside. A pipe 61 is connected between the bottom of the water tank 10 and the bottom of the air storage cylinder 11, a three-way valve 62 is connected to the pipe 61 so as to control the pipe 61 to communicate between the water tank 10 and the air storage cylinder 11. Two one-way valves 13 are located in the tank 10 and communicate with the air storage cylinder 11. Two buoys 23, 24 are located in the water tank 10 and movable along two slipper pillars 21, 22. The two buoys 23, 24 are located corresponding to the two one-way valves 13 and a chain 31 is connected between the two buoys 23, 24 so as to drive an electric generating set 40. The two buoys 23, 24 moves upward and downward alternatively to drives the chain 31 to drive the electric generating set 40.

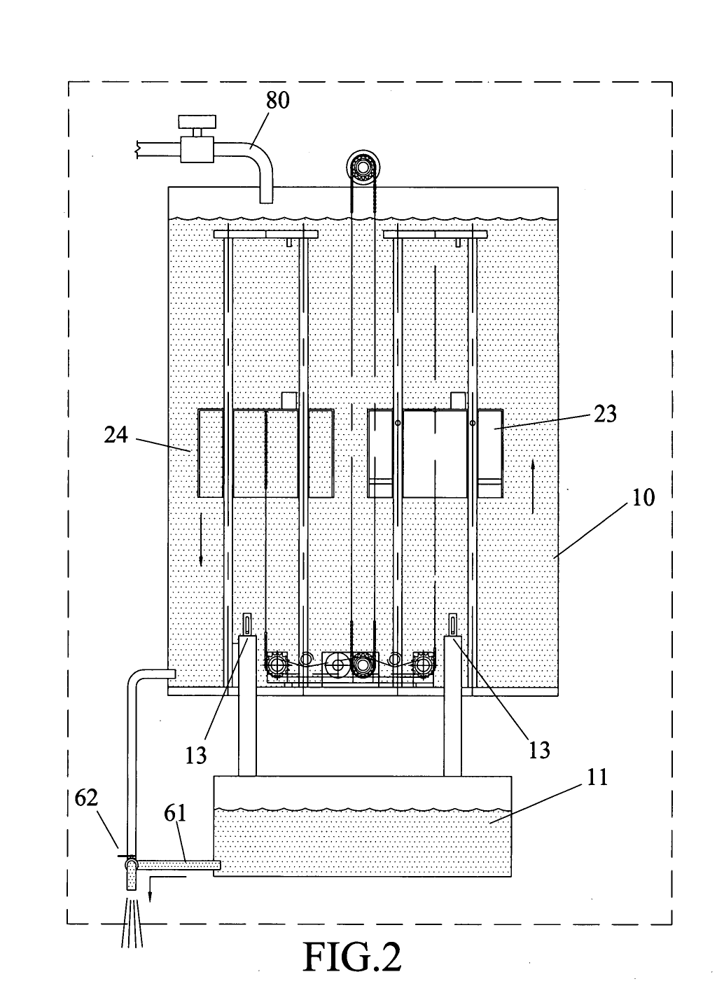

When the buoy 23 is filled with water and located at the low position in the water tank 10, the other buoy 24 is located at high position and the three-way valve 62 communicates the pipe 61 so that the water in the tank 10 flows into the air storage cylinder 11 to compress the air in the air storage cylinder 11 into the buoy 23 via the one-way valve 13. The water in the buoy 23 is forced out by the air. In the meanwhile the one-way valve 52 on the buoy 24 touches the trigger pipe 54 so that the air in the buoy 24 is released to the outside of the tank 10 and water enters into the buoy 24. Therefore, the buoy 23 moves upward and the buoy 24 moves downward. The three-way valve 62 is then shut off and the water in the air storage cylinder 11 flows out as shown in FIG. 2 and air enters into the air storage cylinder 11 again.

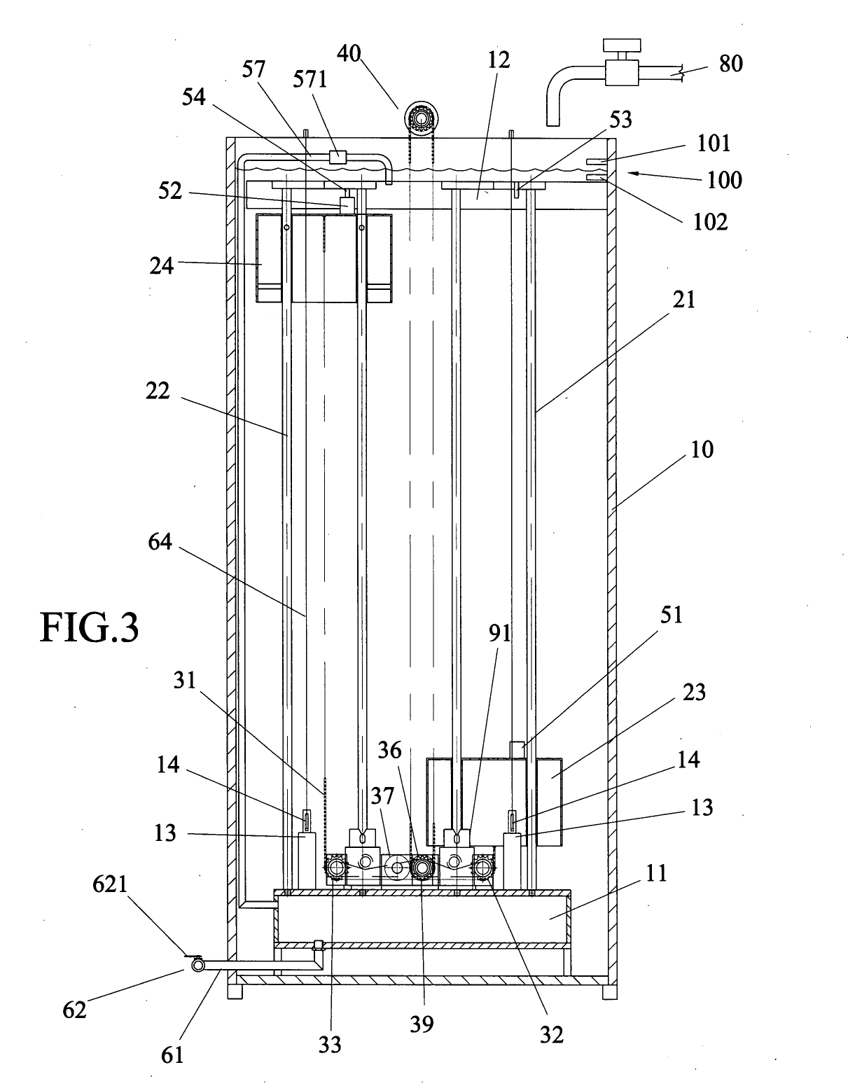

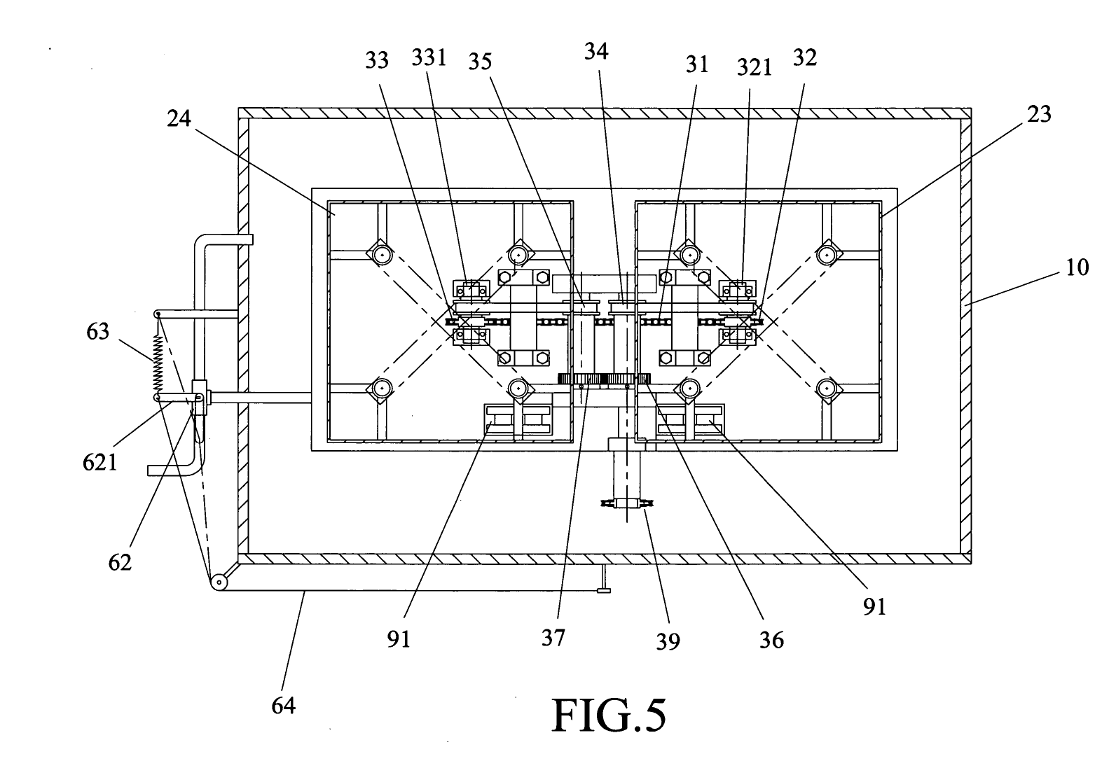

As shown in FIGS. 3 to 5, two respective one-way bearings are installed to the two chain wheels 32, 33. The operation directions of the two one-way bearings are opposite to each other so that only one of the two axles 321, 331 of the two chain wheels 32, 33 is rotated when the chain 31 moves upward or downward. The axles 321, 331 of the two chain wheels 32, 33 are linked by a belt pulley set 34, 35 to the mutually engaged gears 36, 37, and one gear 36 is connected to an output shaft 38, and the chain wheel 39 of the output shaft 38 is linked with an electric generating set 40.

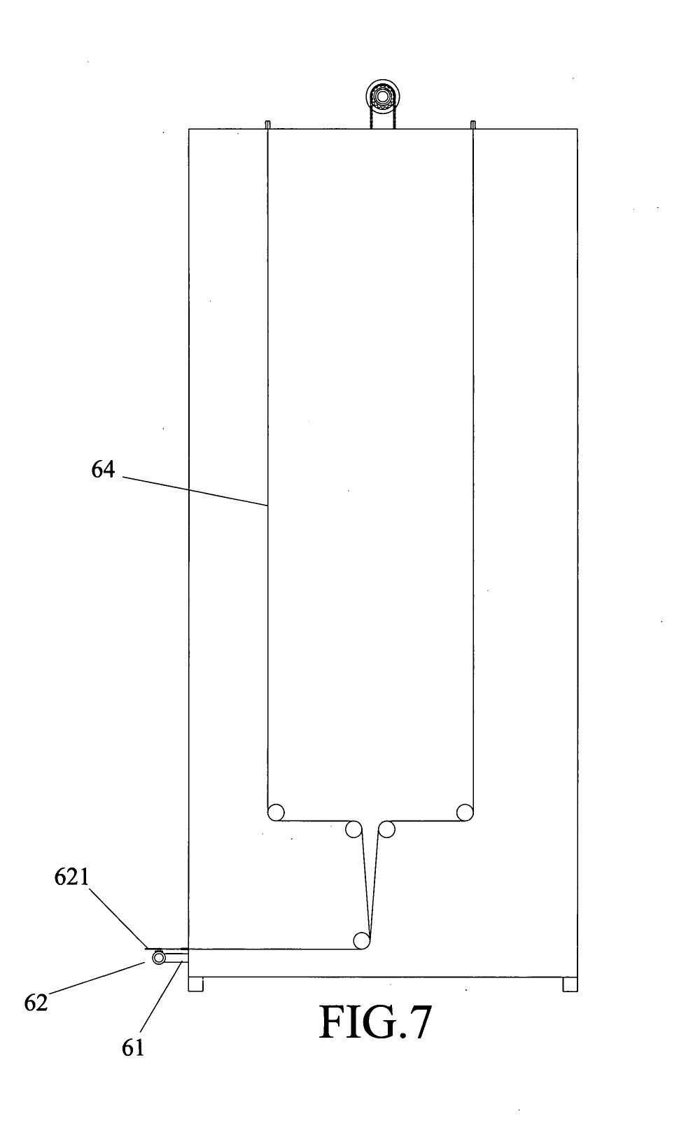

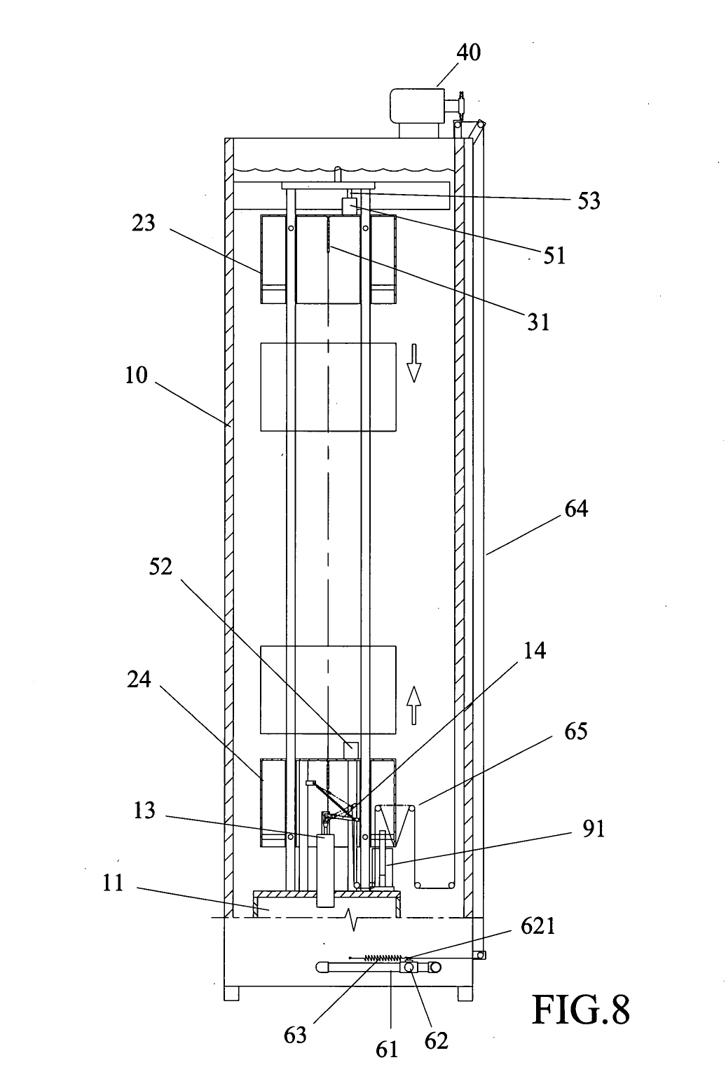

The buoy 23 also includes a one-way valve 51 connected to the top thereof and the one-way valve 51 is located corresponding to the trigger pipe 54. An air storage hood 12 is located in the water tank 10 and merged in the water level. A pipe 57 is connected between the bottom of the air storage cylinder 11 and a top of the air storage hood 12. A one-way valve 571 is connected to and the air duct 56 to prevent the pressure of the air storage cylinder 11 to flow back to the air storage hood 12. Referring to FIGS. 7 and 8, the three-way valve 62 includes a handle 621 which has one end connected with a resilient member 63 and the other end of the handle 621 is connected a rope 64 which is wound around the link rod 14 of the one-way valve 13 at the top of the air storage cylinder 11 from the top of the water tank 10 by a pulley set 65 between the edges of the buoys 23, 24, and thus the buoy 23, 24 are able to press the rope 64 to drive the globe valve 62.

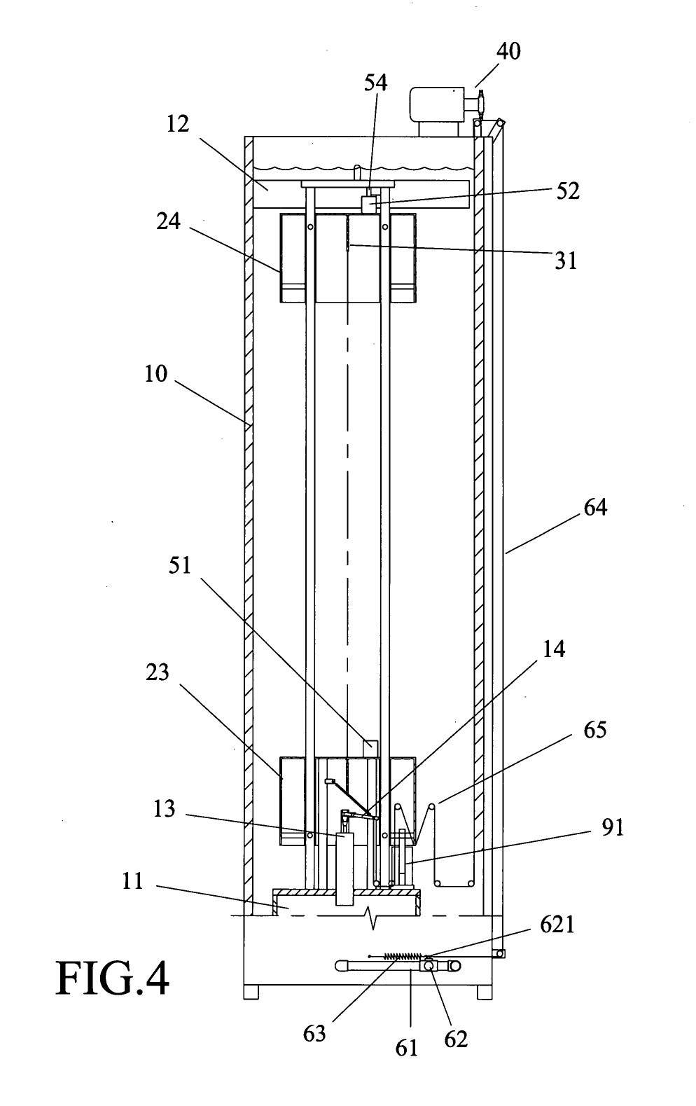

When the buoy 23 is located at the lowest position since the interior is filled up with water, and the other buoy 24 is located at the highest position since the interior is filled up with air, the edge of the buoy 23 presses the rope 64 (as shown in FIG. 4) which then drives the link rod 14 to open the one-way valve 13. In the meantime, the other end of the rope 64 operates the globe valve 62, so that the pipe 61 communicate between the water tank 10 and the air storage cylinder 11, and the water in the water tank 10 enters into the air storage cylinder 11 due to the water pressure and the air in the air storage cylinder 11 escapes into the buoy 23 via the one-way valve 13 and forces water out from the buoy 23. Therefore, the buoy 23 is filled with air and is separated from the clamping of an elastic clamp 91 and moves upward.

The buoy 24 at the highest position is filled up with air and the one-way valve 52 at the top of the buoy 24 is pushed by the trigger pipe 54 and is opened. The water in the water tank 10 flows into the buoy 24 and compresses the air into the air storage hood 12, until all of the air is discharged out of the buoy 24, and the water also fills up the buoy 24.

The air storage hood 12 is merged in the water and the water is forced to flow out from the air storage hood 12 when the air from the buoy 24 into the air storage hood 12, and the air will remain in the air storage hood 12. The one-way valve 571 prevents the air at the air storage cylinder 11 from flowing back into the air storage hood 12 at the top.

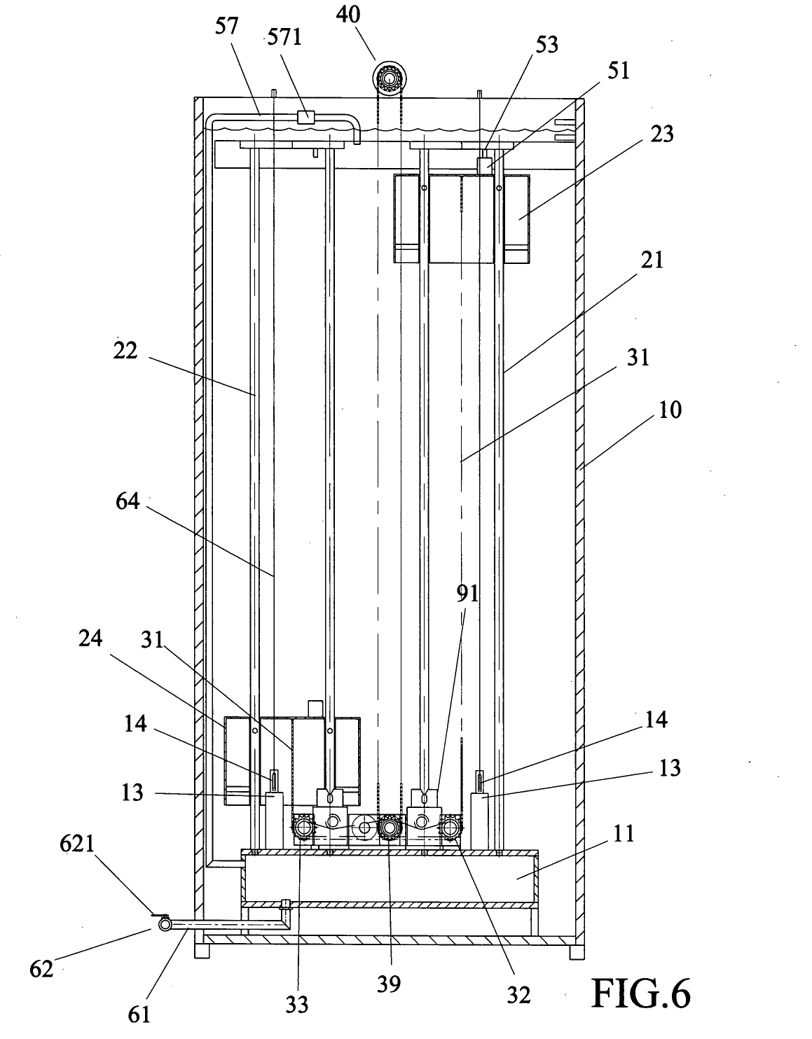

As shown in FIG. 6, the buoy 23 moves to the highest position and the buoy 24 moves to the lowest position. The chain 31 is driven by the movement of the two buoys 23, 24 and also drives the belt pulley set 34, 35. Since the two chain wheels 32, 33 are installed with two respective one-way bearings 321, 331. Only the chain wheel 32 is moved rotated and the other chain wheel 33 runs without driving the chain wheel 33. The rising buoy 23 drives the belt pulley set 34 to drive the output shaft 38, and further the chain wheel 39 drives the electric generating set 40 to generate electric power.

The way of the air and water move to move the buoy 23 down to the lowest position and move the buoy 24 to the highest position again is the same as the description in FIGS. 1 to 6 as long as the water tank 10 is always kept at full level. In other words, by push the air in the air storage cylinder 11 to the buoy 23 or 24 via the opened one-way valve 13 to move the buoy 23 or 24 at the lowest position to the highest position, and by releasing the air in the buoy 24 or 23 at the highest position via the one-way valve 52 or 51, and by filling water into the buoy 24 or 23 at the highest position to move the buoy 24 or 23 down to the lowest position, the electric generating set 40 can be operated to generate electric power.

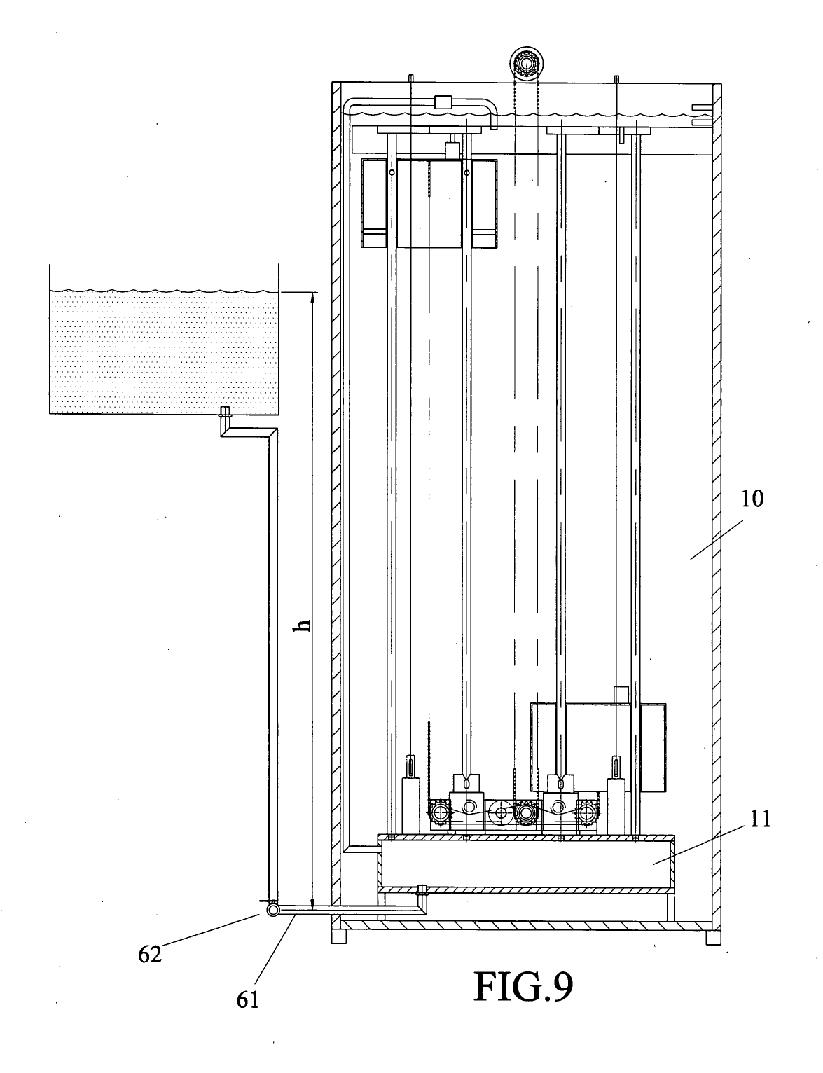

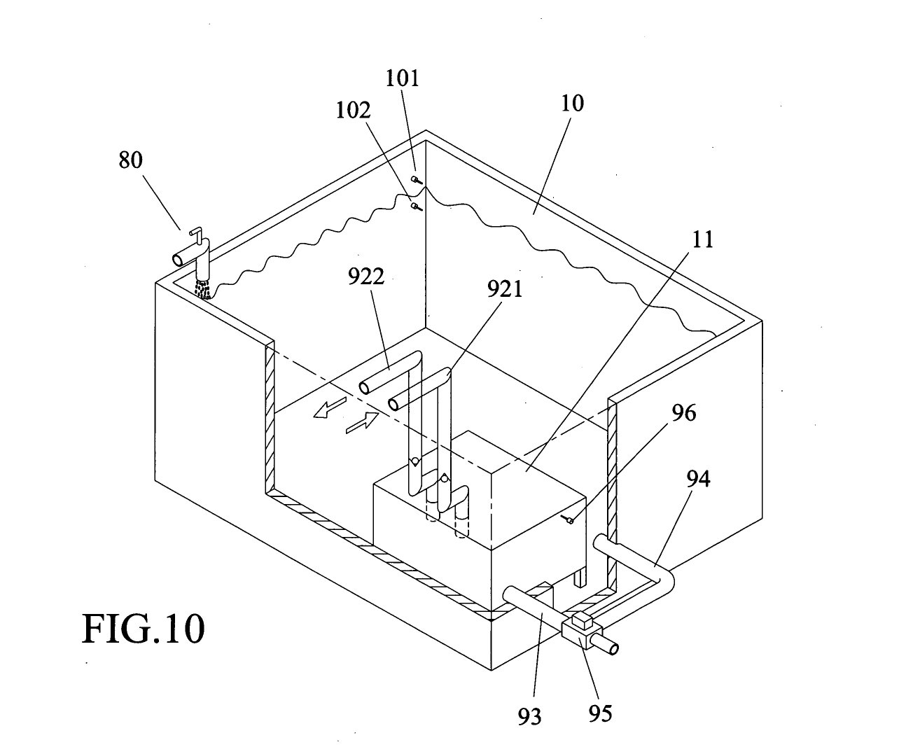

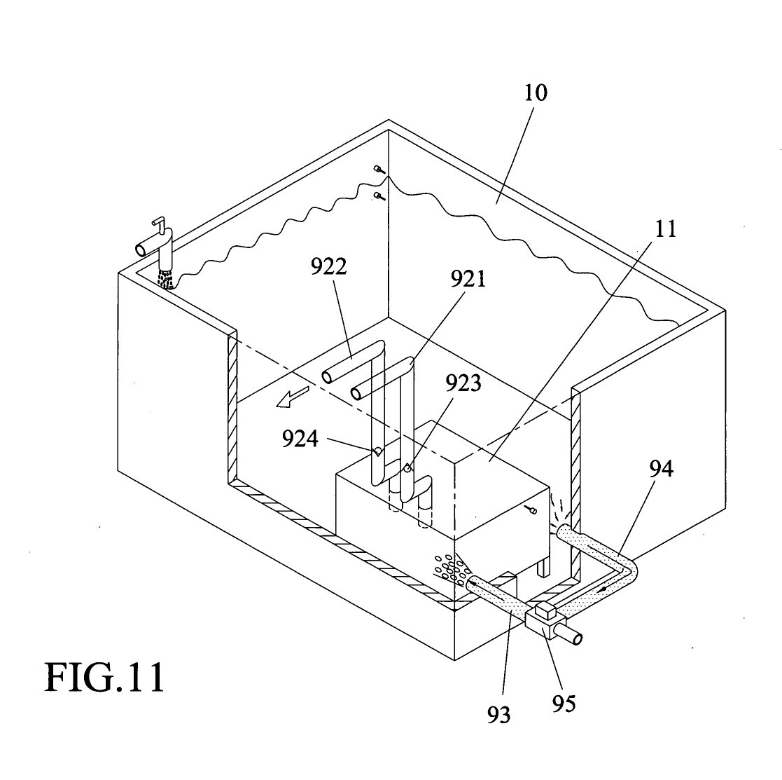

FIGS. 9 to 13 show another embodiment of the present invention, wherein a second water tank is arranged at a certain height “h” from the bottom of the underside of the air storage cylinder 11 and the water pressure in the second water tank is sufficient to force the air in the air storage cylinder 11 out from the air storage cylinder 11. The pipe 61 as shown in FIG. 3 can be omitted and the water in the first water tank 10 does not need to flow in the air storage cylinder 11 anymore. The water in the second water tank can be any source of liquid such as water in ponds or even oil-based liquid.

The air storage cylinder 11 includes a inlet pipe 921 and an outlet pipe 922, both of which communicates with outside of the water tank 10. A water pipe 93 extends from the air storage cylinder 11 and extends out from the water tank 10. A connection pipe 94 is connected to a lower portion of the water tank 10 and is connected to the water pipe 93 by a pressure control valve 95 which controls the volume of the liquid entering into the air storage cylinder 11, or the volume of the liquid leaving from the water tank 10.

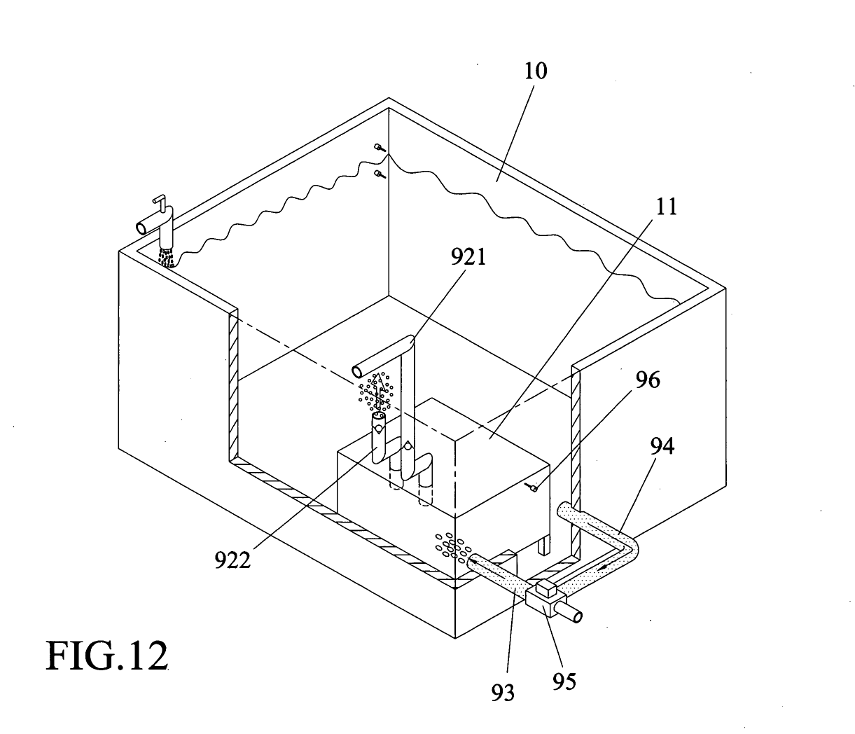

The connection pipe 94 has a certain pressure from the water in the water tank 10 and the interior of the air storage cylinder 11 communicates with the atmosphere via the inlet pipe 921 and outlet pipe 922. The water is guided into the air storage cylinder 11 via the connection pipe 94 and the water pipe 93 when the pressure control valve 95 is opened so as to force the air in the air storage cylinder 11 out from the air storage cylinder 11 via the outlet pipe 922 which can be connected with an appliance such as a compressor. A one-way valve 924 is used to prevent the air from flowing reversely. As shown in FIG. 12, the air can also be guided into the water tank 10 to generate bubbles to provide oxygen to the fishes in the water tank 10. A one-way valve 923 is used to prevent the water from re-entering into the air storage cylinder 11. A level detector 96 is installed in the air storage cylinder 11 such that the pressure control valve 95 is shut off when the liquid reaches the high level position.

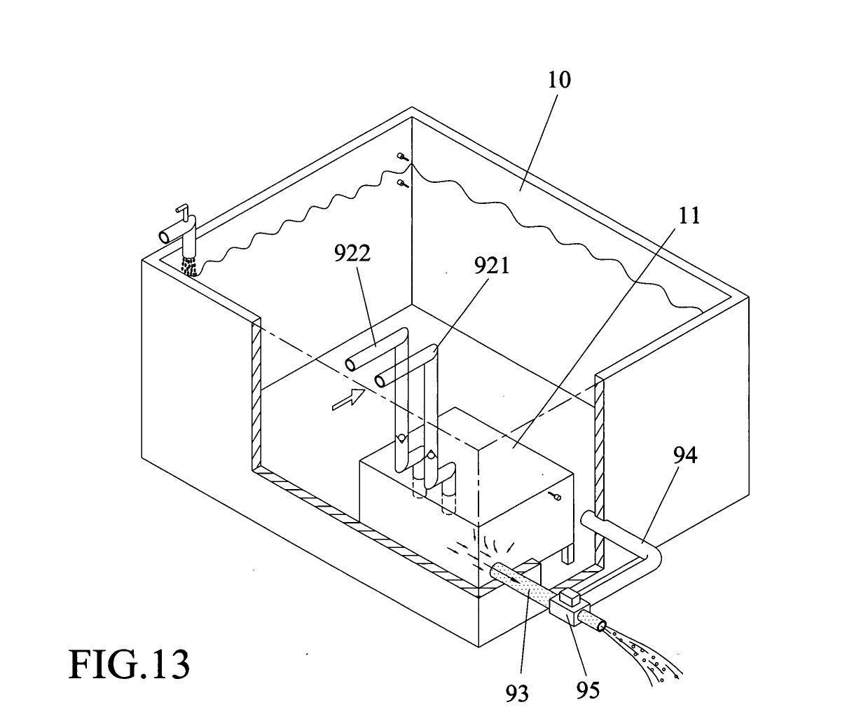

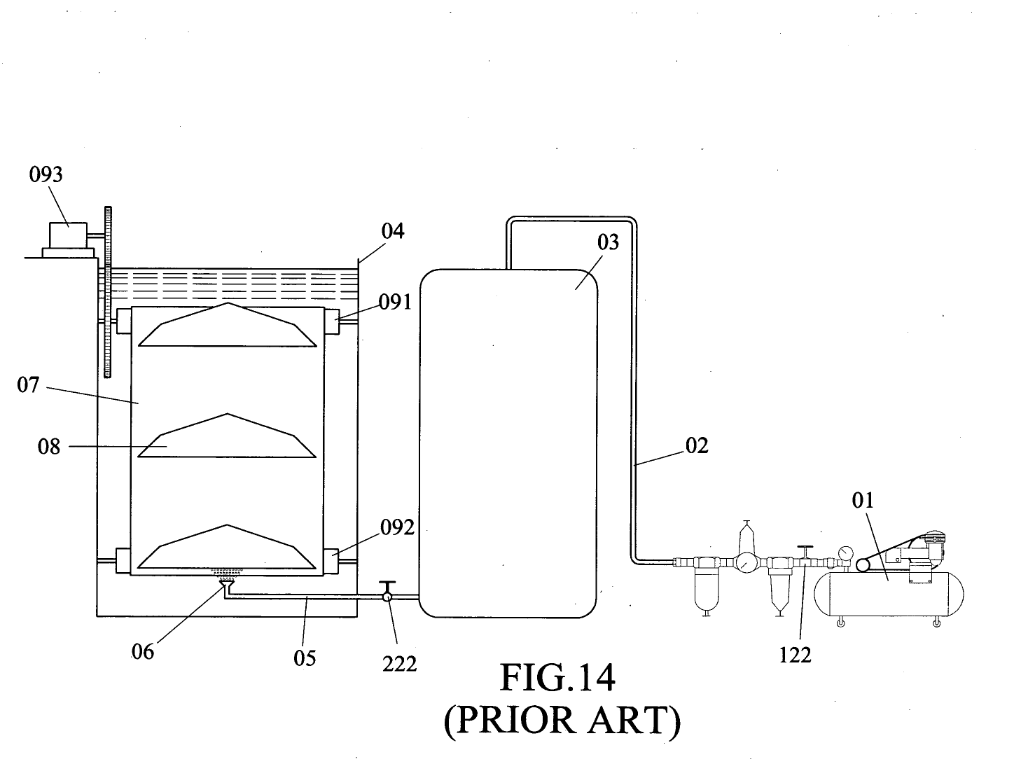

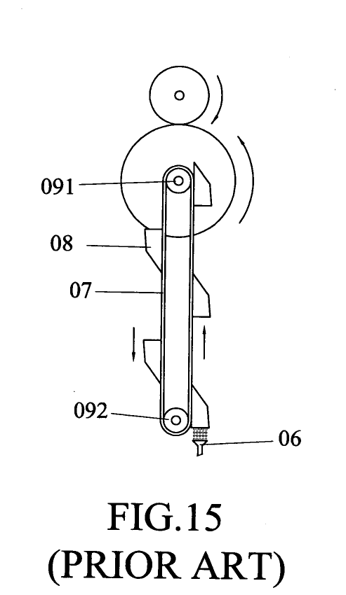

As shown in FIG. 13, when the liquid in the air storage cylinder 11 reaches the high level position, the connection pipe 94 is closed by the pressure control valve 95 so that the liquid in the air storage cylinder 11 flows out from the air storage cylinder 11 via the outlet pipe 93 and air enters into the air storage cylinder via the inlet pipe 921. If the water tank 10 is provided with water by a water supply source 80 such as a faucet as shown in FIG. 13, an upper level detector 101 and a low level detector 102 are connected to the water tank 10 so as to control the water supply source 80 to keep the water level at the high or full level.

While we have shown and described the embodiment in accordance with the present invention, it should be clear to those skilled in the art that further embodiments may be made without departing from the scope of the present invention.

What is claimed is:

1. A hydraulic buoyancy kinetic energy apparatus comprising:
a water tank filled with water and an air storage hood merged in the water, two slippery pillars located in the water tank and two buoys movably connected to the two slippery pillars, a chain connected with the two buoys via two chain wheels, two respective axes of the two chain wheels connected to each other by two belt pulley sets and two engaged gears being mounted to the two belt pulley sets, one of the two gears having an output shaft and a third chain wheel connected to the output shaft, the third chain wheel connected to an electric generating set, and
an air storage cylinder connected with the water tank and air in the air storage cylinder being pushed out from the air storage cylinder by introducing the water from the water tank, two respective one-way valves connected on two respective tops of the two buoys and located corresponding two trigger pipes on the air storage hood, an air duct connected between the air storage hood and the air storage cylinder, a one-way valve connected to the air duct, a pipe connected between a lower portion of the water tank and the air storage cylinder, a three-way valve connected to the pipe, the three-way valve having a handle which has one end thereof connected to a resilient member and the other end of the handle connected to a rope which is connected to a link rod on each of the one-way valves via a pulley set, the rope being pulled by either one of the two buoys so as to activate the three-way valve.

2. The apparatus as claimed in claim 1, wherein each of the two chain wheels has a one-way bearing connected thereto and the two respective one-way bearings rotate in opposite directions so that only one of the two chain wheels is rotated when the chain is moved.

3. A hydraulic buoyancy kinetic energy apparatus comprising:
a water tank filled with water and an air storage hood merged in the water, two slippery pillars located in the water tank and two buoys movably connected to the two slippery pillars, a chain connected with the two buoys via two chain wheels, two respective axes of the two chain wheels connected to each other by two belt pulley sets and two engaged gears being mounted to the two belt pulley sets, one of the two gears having an output shaft and a third chain wheel connected to the output shaft, the third chain wheel connected to a electric generating set, and
an air storage cylinder received in the water tank and including an inlet pipe and an outlet pipe connected thereto, both of the inlet pipe and the outlet pipe communicating with outside of the water tank, a water pipe extending from the air storage cylinder and extending out from the water tank, a connection pipe extending from the water tank and connected to the water pipe by a pressure control valve which controls a volume of water entering into the air storage cylinder or a volume of water that flows out from the air storage cylinder.

4. The apparatus as claimed in claim 3, wherein each of the two chain wheels has a one-way bearing connected thereto and the two respective one-way bearings rotate in opposite directions so that only one of the two chain wheels is rotated when the chain is moved.

5. The apparatus as claimed in claim 1 further comprising a second water tank which is located at a height from the air storage cylinder, a pipe is connected between the water tank and the second water tank.
